(19) United States
(12) Patent Application Publication
(10) Pub. No.: US 2026/0037139 A1
(43) Pub. Date: Feb. 5, 2026

(54) PARTIAL BLOCK ALLOCATIONS FOR MEMORY SYSTEMS

(71) Applicant: Micron Technology, Inc., Boise, ID (US)

(72) Inventors: Caixia Yang, Boise, ID (US); Laskhmi Kalpana Kumar Vakati, San Jose, CA (US); Srinivasa Anuradha Bulusu, Boise, ID (US); Hope Hatfield, Boise, ID (US); Sheng-Huang Lee, Meridian, ID (US)

(21) Appl. No.: 19/281,264

(22) Filed: Jul. 25, 2025

Related U.S. Application Data
(60) Provisional application No. 63/677,300, filed on Jul. 30, 2024.

(51) Int. Cl. G06F 3/06

(52) U.S. Cl. CPC G06F 3/0616; G06F 3/064; G06F 3/0673

(57) ABSTRACT

Methods, systems, and devices for partial block allocations for memory systems are described. A memory system may allocate partial blocks of a memory device for storage of data. In some examples, one or more full blocks across a set of layers of the memory device may be allocated for data storage. Additionally, one or more partial blocks across a subset of the set of layers of the memory device may be allocated for data storage, such as user data or system data. Accordingly, a total utilization of the memory may be increased, thereby increasing the overall capacity of the memory device. As such, the memory system may provide additional storage for a user or additional storage for supporting memory system operations, including overprovisioning for garbage collection or error correction operations.

### CROSS REFERENCE

The present Application for Patent claims priority to U.S. Patent Application No. 63/677,300 by Yang et al., entitled “PARTIAL BLOCK ALLOCATIONS FOR MEMORY SYSTEMS,” filed Jul. 30, 2024, which is assigned to the assignee hereof, and which is expressly incorporated by reference in its entirety herein.

### TECHNICAL FIELD

The following relates to one or more systems for memory, including partial block allocations for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports partial block allocations for memory systems in accordance with examples as disclosed herein.

FIG. 2 shows an example of an array architecture that supports partial block allocations for memory systems in accordance with examples as disclosed herein.

FIG. 3 shows an example of a block allocation that supports partial block allocations for memory systems in accordance with examples as disclosed herein.

FIG. 4 shows a block diagram of a memory system that supports partial block allocations in accordance with examples as disclosed herein.

FIG. 5 shows a flowchart illustrating a method or methods that support partial block allocations for memory systems in accordance with examples as disclosed herein.

### DETAILED DESCRIPTION

Some memory systems, such as Universal Flash Storage (UFS) systems, may implement one or more memory arrays in accordance with a divided-block (e.g., physical block) architecture, such as a paired block architecture. For example, a block (e.g., a physical block, a full block, a full good block) may include a first partial block (e.g., a half good block) associated with a first deck (e.g., a first set of one or more levels above a substrate) and a second partial block associated with a second deck (e.g., a second set of one or more levels above the substrate). In some cases, one or more partial blocks of a memory device may not be allocated for storage of data. For example, a manufacturing process (e.g., processing inconsistencies, processing limitations) may result in defects in one or more levels (e.g., layers) of a deck, and one or more partial blocks may be restricted from being allocated (e.g., idle, unused, unallocated). In some cases, however, such allocation techniques may result in one or more partial blocks of a deck being unable to be paired with another partial block in a different deck, which may limit an amount of storage space available for allocation in a memory device. Additionally, or alternatively, in some cases, a memory device may not have logic for accessing a partial block, and a limited quantity of full blocks may thus limit a total memory capacity of the memory device.

In accordance with examples as described herein, a memory system may be configured to support a flexible allocation and access of blocks of memory cells formed in accordance with quantity of levels (e.g., layers) above a semiconductor substrate. In some examples, one or more full blocks across a set of levels may be allocated (e.g., by a controller) for data storage. Additionally, one or more partial blocks across a subset of the set of levels of the memory device may be allocated for data storage (e.g., user data, system data), which may be accessible independently from other full blocks and partial blocks. By supporting allocations and access of both full blocks and partial blocks, a total available space of a memory device (e.g., of memory cells of the memory device) may be adjusted upward, thereby increasing the accessible capacity of the memory device. As such, the memory system may provide additional storage for a user or additional storage for supporting memory system operations (e.g., firmware, garbage collection, wear leveling, refresh, error correction, block retirement).

In addition to applicability in memory systems as described herein, techniques for partial block allocations in memory systems may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by improving the utilization of partially functioning blocks as a result of manufacturing process limitations and improving system capacities, thereby improving media management operations such as garbage collection, wear leveling, refresh, and block retirement, which may support extending device lifespans and reducing electronic waste, among other benefits.

Features of the disclosure are illustrated and described in the context of systems, devices, and circuits. Features of the disclosure are further illustrated and described in the context of array architectures, allocations, and flowcharts.

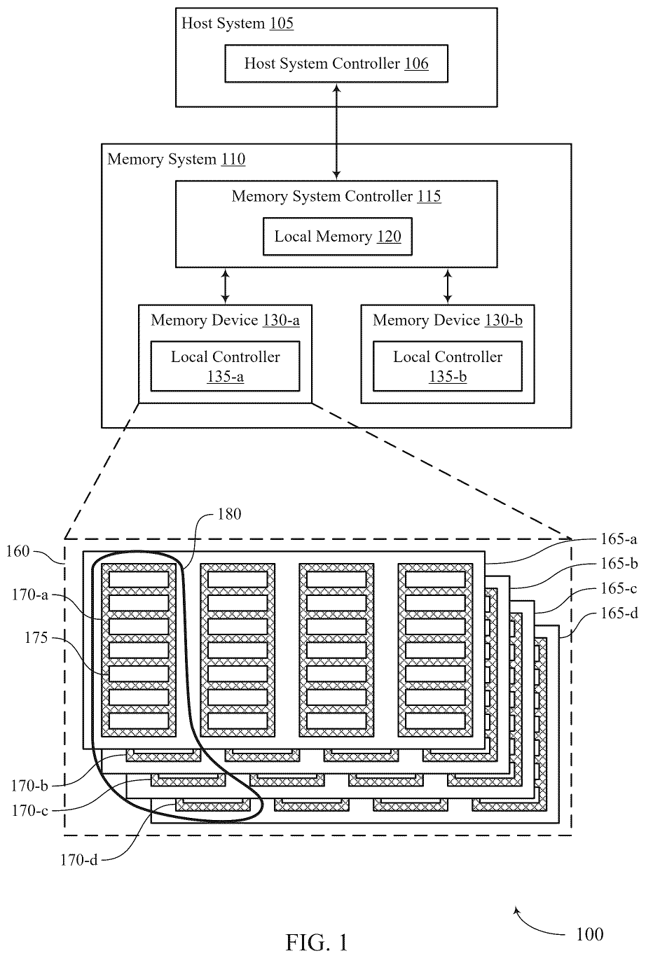

FIG. 1 shows an example of a system 100 that supports partial block allocations for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a UFS device, an embedded Multi-Media Controller (cMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130-among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may include one or more memory devices 130 that are configured in accordance with a divided-block architecture, such as a paired block architecture. For example, a block 170 (e.g., a physical block, a full block, a full good block) may span a set of levels (e.g., a set of layers, a set of pages 175) of a plane 165 of a memory device 130. The block 170 may include a first partial block (e.g., a half block, a half good block) corresponding to a first subset of the set of levels (e.g., a first subset of pages 175) and a second partial block corresponding to a second subset of the set of levels (e.g., a second subset of pages 175). In some cases, one or more partial blocks of the memory device 130 may not be allocated for storage of data. For example, inconsistencies during a manufacturing process may result in defects in one or more levels of the memory device 130, and one or more partial blocks may be restricted from being allocated (e.g., may be idle, unused, unallocated). In some cases, however, such allocation techniques may result in one or more partial blocks (e.g., which may be unaffected by the manufacturing inconsistencies) being unable to be paired to another partial block, thereby limiting the quantity of blocks 170 of the memory device 130 available to be allocated for data storage and reducing the capacity of the memory device 130.

In accordance with examples as described herein, a memory system 110, or memory device(s) 130 thereof, may be configured to support a flexible allocation and access of blocks 170 that are formed in accordance with quantity of levels above a semiconductor substrate. In some examples, one or more full blocks 170 across a set of levels may be allocated (e.g., by a memory system controller 115, by a local controller 135) for data storage. Additionally, one or more partial blocks across a subset of the set of levels of the memory device 130 may be allocated for data storage (e.g., user data, system data), which may be accessible independently from other full blocks and partial blocks. By supporting allocations and access of both full blocks and partial blocks, a total available space of a memory device 130 may be increased, thereby increasing the accessible capacity of the memory device. As such, the memory system 110, or memory device(s) 130 thereof, may provide additional storage for a user or additional storage for supporting memory system operations (e.g., firmware, garbage collection, wear leveling, refresh, error correction, block retirement).

The system 100 may include any quantity of non-transitory computer readable media that support partial block allocations for memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

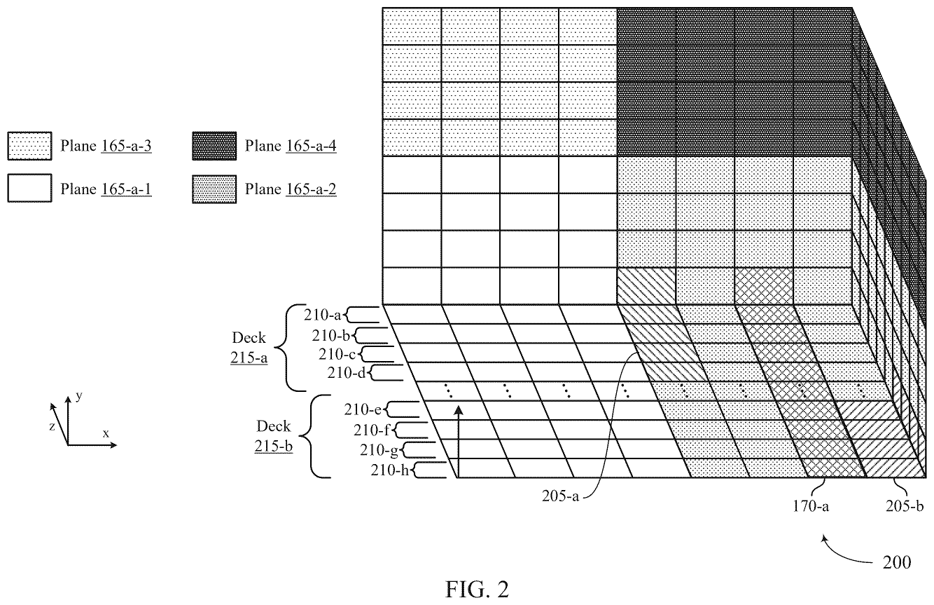

FIG. 2 shows an example of an array architecture 200 that supports partial block allocations for memory systems in accordance with examples as disclosed herein. Aspects of an array architecture 200 may be described with reference to an x-direction, a y-direction, and a z-direction of the illustrated coordinate system. In some implementations, the z-direction may be illustrative of a direction (e.g., a vertical direction, a thickness direction, a direction along which levels are stacked) that is orthogonal to or otherwise relative to a surface in an xy-plane (e.g., a substrate plane, a die plane, a plane of a die 160). Although FIG. 2 illustrates examples of relative dimensions and quantities of various features, aspects of an array architecture 200 may be implemented with other relative dimensions or quantities of such features in accordance with examples as disclosed herein.

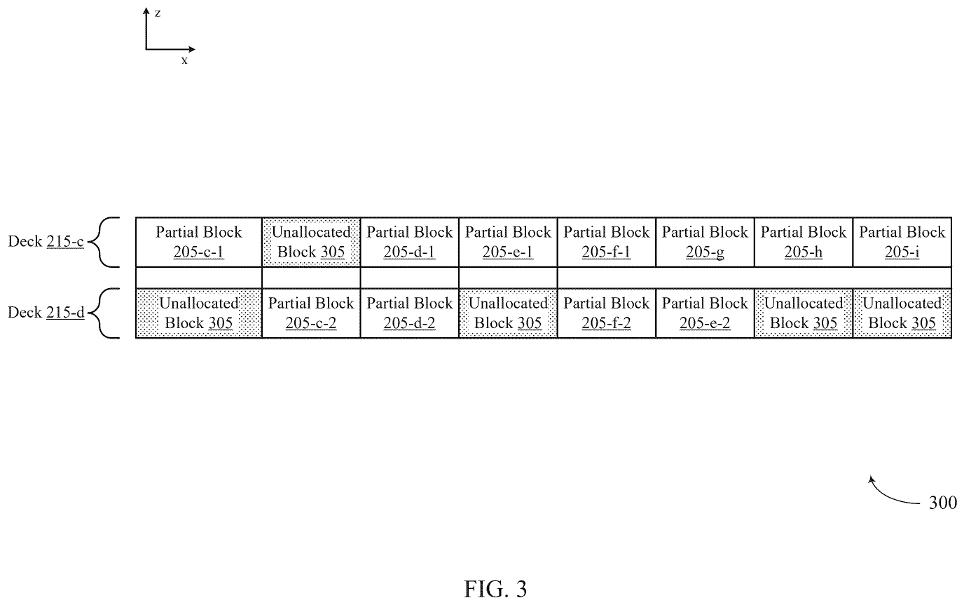

An array architecture 200 may be implemented by one or more memory devices 130 (e.g., in each of one or more dies 160) of a memory system 110 to support partial block allocations. For example, a memory device 130 may include one or more memory arrays in accordance with the array architecture 200, in which memory cells are formed in a quantity of levels 210 above (e.g., along the z-direction) a semiconductor substrate (e.g., of a die 160, not shown). A level 210 may refer to a set (e.g., a layer, a two-dimensional set) of memory cells that span an area in an xy-plane (e.g., along the x-direction, along the y-direction), and a quantity of levels 210 may correspond to a quantity of layers in which memory cells are formed above a semiconductor substrate. Although the example of FIG. 3 illustrates a particular set of levels 210, (e.g., levels 210-a, 210-b, 210-c, 210-d, 210-c, 210-f, 210-g, and 210-h), an array architecture 200 in accordance with the described techniques may include any quantity of multiple levels 210 (e.g., 232 levels, more than 232 levels).

In some examples, an array architecture 200 may be organized in accordance with one or more planes 165-a (e.g., planes 165-a-1, 165-a-2, 165-a-3, 165-a-4). A plane 165-a in accordance with the array architecture 200 may refer to a set (e.g., a three-dimensional set) of memory cells that span a set of levels 210 (e.g., all levels 210) along the z-direction. In some examples, a plane 165-a may be divided (e.g., along the x-direction, along the y-direction, or both) into a set of blocks 170-a (e.g., physical blocks), where a block 170-a may refer to a set (e.g., a three-dimensional set) of memory cells that span the set of levels 210 (e.g., all levels) along the z-direction. In some examples, each level 210 of a block 170-a may correspond to a page 175, such that a quantity of pages 175 in a block 170-a may be equal to a quantity of levels 210 (e.g., of the block 170-a, of the plane 165-a, of the array architecture 200, of the memory device 130, in a 1:1 correspondence).

In some cases, a set of levels 210 (e.g., of the array architecture 200, for each plane 165) may be divided into decks 215. For example, a deck 215-a (e.g., an upper deck) may include levels 210-a through 210-d, and a deck 215-b (e.g., a lower deck) may include levels 210-c through 210-h. In some implementations, a set of levels 210 may be divided evenly between the decks 215 (e.g., with each deck 215 having a fraction of levels 210). In some other implementations, one deck 215 may have a different quantity of levels 210 than another deck 215. In some cases, a set of levels 210 may be divided into a different quantity of decks 215 than as shown in FIG. 2 (e.g., more than two decks).

In some examples, an array architecture 200 (e.g., a plane 165, a block 170) may include (e.g., be divided into, be partitioned with, be allocated in accordance with) one or more partial blocks 205 (e.g., half blocks, half good blocks, partial physical blocks), and each partial block 205 may include memory cells spanning across a subset of the levels 210 (e.g., fewer than all levels 210, an integer fraction of levels 210). For example, each partial block 205 may include memory cells spanning a subset set of pages 175 (e.g., of a block 170) along the z-direction, such as a set of pages 175 of a deck 215. For instance, a partial block 205-a may span memory cells (e.g., pages 175) of the deck 215-a (e.g., of at least the levels 210-a, 210-b, 210-c, and 210-d). Similarly, a partial block 205-b may span memory cells (e.g., pages 175) of the deck 215-b (e.g., of at least the levels 210-c, 210-f, 210-g, and 210-h). In some examples, each plane 165 may thus include multiple stacks of partial blocks 205, and each partial block 205 may span a subset of levels 210 (e.g., corresponding to a deck 215) of the respective plane 165.

In some examples, a plane 165 may include an allocation of full blocks (e.g., full good blocks, full block allocations, allocations in accordance with a full block capacity) that span each level 210 of the set of levels 210. In some examples, a full block may refer to a full allocation of a given block 170-a. Additionally, or alternatively, a full block allocation may refer to an allocation of multiple partial blocks 205 that, in total, span each level 210 of the set of levels 210, such as partial blocks 205 of different decks 215 of the plane 165. For example, the plane 165-b may include a full block allocation (e.g., as a configured pair, as a paired block allocation) that includes the partial block 205-a within the deck 215-a and the partial block 205-b within the deck 215-b. In some examples, partial blocks 205 that are configured to form a full block allocation in a respective plane 165 may be aligned (e.g., with a common location, with a common address) along the x-direction, along the y-direction, or both (e.g., as a configured allocation of a block 170-a, as a configuration of partial blocks 205 stacked along the z-direction), or may not be aligned along the x-direction or y-direction.

In some cases, a manufacturing process may result in defects at one or more portions of a level 210 (e.g., within at least a portion of the array architecture 200, within a plane 165), for example, due to non-uniformity in the manufacturing process or limitations of the manufacturing process. As such, one or more partial blocks 205 may not be allocated for storage of data (e.g., may be idle, unused, unallocated). In some cases, this may result in one or more partial blocks 205 (e.g., which may be unaffected by the manufacturing inconsistencies) being unable to be paired with another partial block 205 to form a full block allocation. Some memory systems 110 may be configured to allocate and access data at a full block level (e.g., in accordance with a full block capacity), however. As such, if one or more partial blocks 205 are unable to be paired to another partial block 205 (e.g., in a different deck 215), an overall capacity of the memory device 130 may be limited even if the unpaired partial blocks 205 would otherwise be functional (e.g., operable to store data).

In accordance with examples as described herein, an array architecture 200 may be configured to support a flexible allocation and access of blocks 170 that are formed in accordance with quantity of levels 210 above a semiconductor substrate. In some examples, one or more full blocks (e.g., blocks 170, configured combinations of multiple partial blocks 205, blocks allocated in accordance with a full block capacity) across a set of levels 210 may be allocated (e.g., by a memory system controller 115, by a local controller 135) for data storage. Additionally, one or more partial blocks 205 (e.g., blocks allocated in accordance with a partial block capacity that is less than a full block capacity) across a subset of the set of levels 210 may be allocated (e.g., individually allocated, as a partial block allocation) for data storage (e.g., user data, system data), which may be accessible independently from other full blocks (e.g., blocks 170, configured sets of multiple partial blocks 205) and other partial blocks 205. By supporting allocations and access of both full blocks and partial blocks 205, a total available space of an array architecture 200 may be increased, thereby increasing the accessible capacity of a memory device 130 that includes one or more memory arrays in accordance with the array architecture 200. As such, a memory system 110, or memory device(s) 130 thereof, may provide additional storage for a user or additional storage for supporting memory system operations (e.g., firmware, garbage collection, wear leveling, refresh, error correction, block retirement).

FIG. 3 shows an example of an allocation 300 that supports partial block allocations for memory systems in accordance with examples as disclosed herein. The block allocation 300 may be implemented at one or more memory devices 130 (e.g., one or more dies 160) of a memory system 110 to support partial block allocations, as described herein.

In some examples, a memory device 130 (e.g., a die 160) may include one or more partial blocks 205. Each partial block 205 may span a subset of levels 210 (e.g., a subset of layers) of a set of levels of the memory device 130 (of an array architecture 200, of a block 170). For example, each partial block 205 may correspond to a deck 215, such as a deck 215-c or a deck 215-d. In some cases, memory systems 110 may implement a paired block architecture, where full blocks (e.g., full good blocks) may be allocated in accordance with the set of levels 210. For example, a full block (e.g., a full good block) may be allocated, including a first partial block 205 of the deck 215-c and a second partial block 205 of the deck 215-d.

In some examples, in the paired architecture, a first full block may correspond to a pairing (e.g., a configured pairing, a paired allocation) of a partial block 205-c-1 and a partial block 205-c-2, a second full block may correspond to a pairing of a partial block 205-d-1 and a partial block 205-d-2, a third full block may correspond to a pairing of a partial block 205-c-1 and a partial block 205-c-2, and a fourth full block may correspond to a pairing of a partial block 205-f-1 and a partial block 205-f-2 (e.g., as a full block 170, as a physical block, as a complete physical block, as a configured combination of partial blocks 205 that are stacked along the z-direction).

In some examples, a memory system 110 may be configured to access data in accordance with the paired block architecture (e.g., by accessing full blocks). In some cases, however, the decks 215-c and 215-d may include one or more unallocated blocks 305, which may not be allocated for storage of data (e.g., may be idle, unallocated, unused). For example, inconsistencies during a manufacturing process may result in defects in one or more levels 210, and one or more partial blocks 205 may be restricted from being allocated and may be left as unallocated blocks 305. In some examples, a quantity of unallocated blocks 305 may be different between the deck 215-c and the deck 215-d, resulting in different quantities of partial blocks 205 for each of the decks 215-c and 215-d. As such, a deck 215-c may be allocated with one or more partial blocks, such as a partial block 205-g, a partial block 205-h, and a partial block 205-i, which may not be able to be paired to a partial block 205 of the deck 215-d. For implementations in which a memory system 110 is configured to access data in accordance with full blocks (e.g., full block allocations), the unpaired partial blocks 205 may not be accessed, resulting in a decreased effective capacity of the memory system 110.

In accordance with examples as described herein, the memory system 110 may allocate partial blocks 205 independently of the paired architecture. For example, the partial blocks 205-g, 205-h, and 205-i may be allocated for storing data, regardless of whether there is another available partial block 205 in the deck 215-d for pairing. Additionally, the memory system 110 may implement logic configured to access the partial blocks 205-g, 205-h, and 205-i independently of whether there is a corresponding paired partial block 205, thereby increasing the availability of memory cells for each memory device 130 of the memory system 110.

In some examples, at least some partial blocks 205 of a memory device 130 that are part of a corresponding pair may still be allocated as a full block. For example, a first storage space including the partial block 205-a-1 and the partial block 205-a-2 may be allocated as a full block spanning the set of levels 210 (e.g., of the decks 215-c and 215-d). Additionally, or alternatively, partial blocks 205 may (e.g., all) be allocated independently of other partial blocks 205. For example, a second storage space may be allocated corresponding to the partial block 205-b-1, which may be accessed independently of partial block 205-b-2. Thus, in accordance with these and other examples, an allocation 300 may include an allocation of first storage space of one or more first blocks (e.g., blocks 170, combinations of partial blocks 205, full blocks) in accordance with all levels 210 (e.g., all decks 215) and an allocation of second storage space of one or more second blocks (e.g., portions of blocks 170, partial blocks 205) in accordance with a subset of the levels 210 (e.g., individual decks 215).

In some examples, the first storage space (e.g., corresponding to one or more full blocks) may be allocated for storing user data, and the second storage space (e.g., corresponding to one or more partial blocks 205) may be allocated for storing system information. For example, one or more partial blocks 205 of the second storage space (e.g., the partial block 205-g, the partial block 205-h, the partial block 205-i, or other blocks) may be allocated as a firmware block (e.g., for storing firmware information or code), as a system block of the memory system 110, as a replay-protected memory block (RPMB) or a combination thereof. Additionally, or alternatively, one or more partial blocks 205 of the second storage space may (e.g., also) be allocated for storing user data.

In some examples, the memory system 110 may implement one or more overprovisioning blocks (e.g., as partial blocks 205, as full blocks). For example, the memory system 110 may reserve one or more blocks for use by system processes, such as garbage collection, wear leveling, refresh, block retirement, or other media management. In some cases, the memory system 110 may be configured to provide a first storage capacity (e.g., 256 gigabytes (GB), 512 GB, 1 terabyte) for user data (e.g., or user data and system data), and the memory system 110 may be configured to provide a second storage capacity (e.g., 8 GB, 16 GB, 32 GB) as overprovisioning for media management or other memory system management. In some examples, one or more partial blocks 205 may be individually allocated for system utilization such as system information (e.g., firmware, replay-protected information) or, in some cases, overprovisioning (e.g., for media management), such that a greater quantity of full blocks (e.g., blocks 170, configured combinations of partial blocks 205) may be separately allocated for the first storage capacity (e.g., for a rated capacity for user data).

In some examples, the memory system 110 may allocate the partial blocks 205 in accordance with a configuration. For example, the memory system 110 may store a configuration in accordance with a manufacturing characteristic of the memory system 110 (e.g., layout characteristics of a memory device 130, layout characteristics of a die 160, a quantity or position of unallocated blocks 305), a location of one or more partial blocks 205 to be allocated, or a combination thereof. These and other techniques may support a memory system 110 (e.g., a memory system controller 115, a local controller 135) allocating first storage space (e.g., in accordance with full blocks), second storage space (e.g., in accordance with independently-accessible partial blocks 205), and refraining from allocating third storage space (e.g., of one or more unallocated blocks 305).

In some examples, the first storage space corresponding to one or more full blocks may be allocated in accordance with a first quantity of decks (e.g., decks 215-c and 215-d, two decks, more than two decks), a first quantity of pages (e.g., a set of pages 175 corresponding to a quantity of levels 210 of an array architecture 200), a first block capacity (e.g., storage capacity, quantity of memory cells), or a combination thereof. Additionally, or alternatively, the second storage space corresponding to one or more partial blocks 205 may be allocated in accordance with a second quantity of decks that is less than the first quantity of decks (e.g., one deck 215), a second quantity of pages 175 that is less than the first quantity of pages 175 (e.g., a quantity less than all pages 175 or levels 210 of the array architecture 200), a second block capacity that is less than the first block capacity, or a combination thereof.

Accordingly, the allocation of the second storage space corresponding to one or more partial blocks 205 (e.g., independently-accessible partial blocks 205, supporting allocations of blocks in accordance with different block capacities, such as full-block capacities and partial-block capacities) may improve the utilization of memory cells by the memory system 110, thereby increasing available or rated storage capacity of the memory system 110.

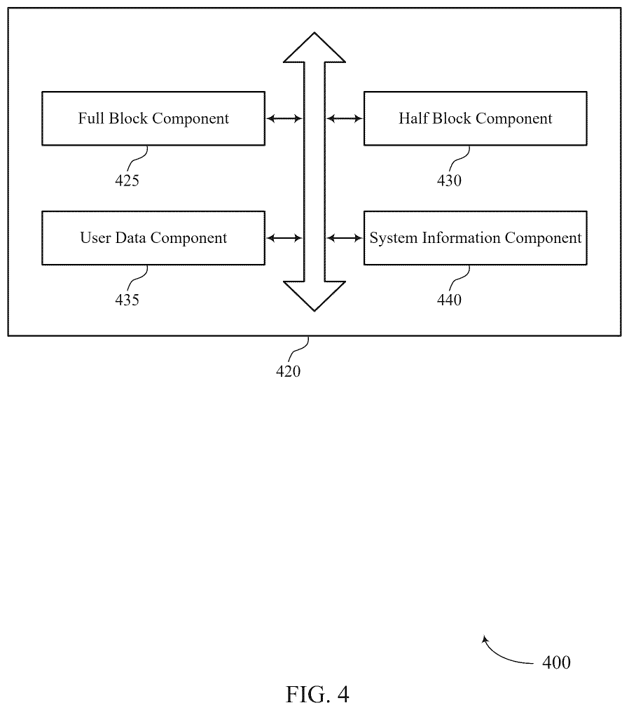

FIG. 4 shows a block diagram 400 of a memory system 420 that supports partial block allocations in accordance with examples as disclosed herein. The memory system 420 may be an example of aspects of a memory system as described with reference to FIGS. 1 through 3. The memory system 420, or various components thereof, may be an example of means for performing various aspects of partial block allocations for memory systems as described herein. For example, the memory system 420 may include a full block component 425, a half block component 430, a user data component 435, a system information component 440, or any combination thereof. In some implementations, the memory system 420 may also include one or more memory devices (e.g., memory device(s) 130, not shown) each comprising one or more memory arrays having memory cells formed in a respective quantity of levels above a semiconductor substrate. Each of these components, or components or subcomponents thereof (e.g., one or more processors, one or more memories), may communicate, directly or indirectly, with one another (e.g., via one or more buses).

The full block component 425 may be configured as or otherwise support a means for allocating a first storage space of one or more first blocks of the memory cells, of a memory device of the one or more memory devices, in accordance with the respective quantity of levels above the semiconductor substrate of the memory device. The half block component 430 may be configured as or otherwise support a means for allocating a second storage space of one or more second blocks of memory cells, of the memory device, in accordance with a subset of the respective quantity of levels above the semiconductor substrate of the memory device.

In some examples, the first storage space of the one or more first blocks may be allocated for storing user data. In some examples, the second storage space of the one or more second blocks may be allocated for storing system information. In some examples, at least one or the one or more second blocks may be allocated as a firmware block of the memory system, as a system block of the memory system, or a combination thereof. In some examples, at least one of the one or more second blocks may be allocated as a replay-protected memory block (RPMB).

In some examples, the half block component 430 may be configured as or otherwise support a means for refraining from allocating a third storage space of the one or more second blocks associated with a second subset of the respective quantity of levels. In some examples, the half block component 430 may be configured as or otherwise support a means for identifying the one or more second blocks, the subset of the respective quantity of levels, or both in accordance with a configuration stored at the memory system. In some examples, the configuration may be in accordance with a manufacturing characteristic of the one or more second blocks of the memory device, a location of the one or more second blocks in the memory device, or a combination thereof.

In some examples, the full block component 425 may be configured as or otherwise support a means for allocating the first storage space in accordance with a first quantity of decks of the memory device, and the half block component 430 may be configured as or otherwise support a means for allocating the second storage space in accordance with a second quantity of decks of the memory device that is less than the first quantity.

In some examples, the full block component 425 be configured as or otherwise support a means for allocate the first storage space in accordance with a first quantity of pages, and the half block component 430 may be configured as or otherwise support a means for allocating the second storage space in accordance with a second quantity of pages that is less than the first quantity.

In some examples, the full block component 425 may be configured as or otherwise support a means for allocating the first storage space in accordance with a first block capacity, and the half block component 430 second storage space may be configured as or otherwise support a means for allocating the second storage space in accordance with a second block capacity that is less than the first block capacity.

In some examples, the half block component 430 may be configured as or otherwise support a means for access each of the one or more second blocks independently from other blocks of the memory device.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

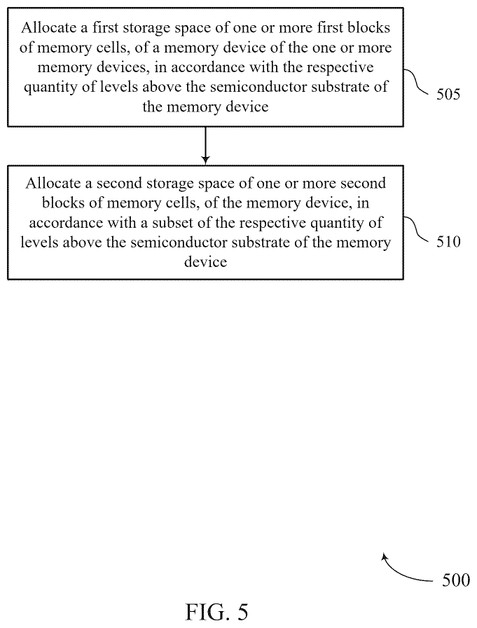

FIG. 5 shows a flowchart illustrating a method 500 that supports partial block allocations for memory systems in accordance with examples as disclosed herein. The operations of method 500 may be implemented by a memory system or its components as described herein. For example, the operations of method 500 may be performed by a memory system as described with reference to FIGS. 1 through 4, and the memory system may include one or more memory devices each comprising one or more memory arrays having memory cells formed in a respective quantity of levels above a semiconductor substrate. In some examples, a memory system may execute a set of instructions to control the functional elements of the device to perform the described functions. Additionally, or alternatively, the memory system may perform aspects of the described functions using special-purpose hardware.

At 505, the method may include allocating a first storage space of one or more first blocks of memory cells, of one or more memory arrays of a memory device formed in a respective quantity of levels above a semiconductor substrate, in accordance with the respective quantity of levels above the semiconductor substrate of the memory device. In some examples, aspects of the operations of 505 may be performed by a full block component 425 as described with reference to FIG. 4.

At 510, the method may include allocating a second storage space of one or more second blocks of memory cells, of the one or more memory arrays of the memory device, in accordance with a subset of the respective quantity of levels above the semiconductor substrate of the memory device. In some examples, aspects of the operations of 510 may be performed by a half block component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for allocating a first storage space of one or more first blocks of memory cells, of one or more memory arrays of a memory device formed in a respective quantity of levels above a semiconductor substrate, in accordance with the respective quantity of levels above the semiconductor substrate of the memory device; and allocating a second storage space of one or more second blocks of memory cells, of the one or more memory arrays of the memory device, in accordance with a subset of the respective quantity of levels above the semiconductor substrate of the memory device.
Aspect 2: The method, apparatus, or non-transitory computer-readable medium of aspect 1, further comprising: allocating the first storage space of the one or more first blocks for storing user data and allocate the second storage space of the one or more second blocks for storing system information.
Aspect 3: The method, apparatus, or non-transitory computer-readable medium of aspect 2, further comprising: allocating at least one or the one or more second blocks as a firmware block of the memory system, as a system block of the memory system, or a combination thereof.
Aspect 4: The method, apparatus, or non-transitory computer-readable medium of any of aspects 2 through 3, further comprising: allocating at least one of the one or more second blocks as a replay-protected memory block (RPMB).
Aspect 5: The method, apparatus, or non-transitory computer-readable medium of any of aspects 1 through 4, further comprising: refraining from allocating a third storage space of the one or more second blocks associated with a second subset of the respective quantity of levels.
Aspect 6: The method, apparatus, or non-transitory computer-readable medium of any of aspects 1 through 5, further comprising: identifying the one or more second blocks, the subset of the respective quantity of levels, or both in accordance with a configuration stored at the memory system.
Aspect 7: The method, apparatus, or non-transitory computer-readable medium of aspect 6, where the configuration is in accordance with a manufacturing characteristic of the one or more second blocks of the memory device, a location of the one or more second blocks in the memory device, or a combination thereof.
Aspect 8: The method, apparatus, or non-transitory computer-readable medium of any of aspects 1 through 7, further comprising: allocating the first storage space in accordance with a first quantity of decks of the memory device and allocate the second storage space in accordance with a second quantity of decks of the memory device that is less than the first quantity.
Aspect 9: The method, apparatus, or non-transitory computer-readable medium of any of aspects 1 through 8, further comprising: allocating the first storage space in accordance with a first quantity of pages and allocate the second storage space in accordance with a second quantity of pages that is less than the first quantity.
Aspect 10: The method, apparatus, or non-transitory computer-readable medium of any of aspects 1 through 9, further comprising: allocating the first storage space in accordance with a first block capacity and allocate the second storage space in accordance with a second block capacity that is less than the first block capacity.
Aspect 11: The method, apparatus, or non-transitory computer-readable medium of any of aspects 1 through 10, further including operations, features, circuitry, logic, means, or instructions, or any combination thereof for access each of the one or more second blocks independently from other blocks of the memory device.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices each comprising one or more memory arrays having memory cells formed in a respective quantity of levels above a semiconductor substrate; and
processing circuitry coupled with the one or more memory devices and configured to cause the memory system to:
allocate a first storage space of one or more first blocks of the memory cells, of a memory device of the one or more memory devices, in accordance with the respective quantity of levels above the semiconductor substrate of the memory device; and
allocate a second storage space of one or more second blocks of the memory cells, of the memory device, in accordance with a subset of the respective quantity of levels above the semiconductor substrate of the memory device.

2. The memory system of claim 1, wherein the processing circuitry is configured to cause the memory system to:
allocate the first storage space of the one or more first blocks for storing user data; and
allocate the second storage space of the one or more second blocks for storing system information.

3. The memory system of claim 2, wherein the processing circuitry is configured to cause the memory system to:
allocate at least one or the one or more second blocks as a firmware block of the memory system, as a system block of the memory system, or a combination thereof.

4. The memory system of claim 2, wherein the processing circuitry is configured to cause the memory system to:
allocate at least one of the one or more second blocks as a replay-protected memory block (RPMB).

5. The memory system of claim 1, wherein the processing circuitry is configured to cause the memory system to:
refrain from allocating a third storage space of the one or more second blocks associated with a second subset of the respective quantity of levels.

6. The memory system of claim 1, wherein the processing circuitry is configured to cause the memory system to:
identify the one or more second blocks, the subset of the respective quantity of levels, or both in accordance with a configuration stored at the memory system.

7. The memory system of claim 6, wherein the configuration is in accordance with a manufacturing characteristic of the one or more second blocks of the memory device, a location of the one or more second blocks in the memory device, or a combination thereof.

8. The memory system of claim 1, wherein the processing circuitry is configured to cause the memory system to:
allocate the first storage space in accordance with a first quantity of decks of the memory device; and
allocate the second storage space in accordance with a second quantity of decks of the memory device that is less than the first quantity.

9. The memory system of claim 1, wherein the processing circuitry is configured to cause the memory system to:
allocate the first storage space in accordance with a first quantity of pages; and
allocate the second storage space in accordance with a second quantity of pages that is less than the first quantity.

10. The memory system of claim 1, wherein the processing circuitry is configured to cause the memory system to:
allocate the first storage space in accordance with a first block capacity; and
allocate the second storage space in accordance with a second block capacity that is less than the first block capacity.

11. The memory system of claim 1, wherein the processing circuitry is further configured to cause the memory system to:
access each of the one or more second blocks independently from other blocks of the memory device.

12. A non-transitory computer-readable medium storing code comprising instructions which, when executed by processing circuitry of an electronic device, cause the electronic device to:
allocate a first storage space of one or more first blocks of memory cells, of one or more memory arrays of a memory device formed in a respective quantity of levels above a semiconductor substrate, in accordance with the respective quantity of levels above the semiconductor substrate of the memory device; and
allocate a second storage space of one or more second blocks of memory cells, of the one or more memory arrays of the memory device, in accordance with a subset of the respective quantity of levels above the semiconductor substrate of the memory device.

13. The non-transitory computer-readable medium of claim 12, wherein the instructions, when executed by the processing circuitry of the electronic device, cause the electronic device to:
allocate the first storage space of the one or more first blocks for storing user data; and
allocate the second storage space of the one or more second blocks for storing system information.

14. The non-transitory computer-readable medium of claim 13, wherein the instructions, when executed by the processing circuitry of the electronic device, cause the electronic device to:
allocate at least one or the one or more second blocks as a firmware block of the electronic device, as a system block of the electronic device, or a combination thereof.

15. The non-transitory computer-readable medium of claim 13, wherein allocate at least one of the one or more second blocks as a replay-protected memory block (RPMB).

16. The non-transitory computer-readable medium of claim 12, wherein the instructions, when executed by the processing circuitry of the electronic device, cause the electronic device to:
refrain from allocating a third storage space of the one or more second blocks associated with a second subset of the respective quantity of levels.

17. The non-transitory computer-readable medium of claim 12, wherein the instructions, when executed by the processing circuitry of the electronic device, cause the electronic device to:
identify the one or more second blocks, the subset of the respective quantity of levels, or both in accordance with a configuration stored at the electronic device.

18. The non-transitory computer-readable medium of claim 17, wherein the configuration is in accordance with a manufacturing characteristic of the one or more second blocks of the memory device, a location of the one or more second blocks in the memory device, or a combination thereof.

19. The non-transitory computer-readable medium of claim 12, wherein the instructions, when executed by the processing circuitry of the electronic device, cause the electronic device to:
allocate the first storage space in accordance with a first quantity of decks of the memory device; and
allocate the second storage space in accordance with a second quantity of decks of the memory device that is less than the first quantity.

20. The non-transitory computer-readable medium of claim 12, wherein the instructions, when executed by the processing circuitry of the electronic device, cause the electronic device to:
allocate the first storage space in accordance with a first quantity of pages; and
allocate the second storage space in accordance with a second quantity of pages that is less than the first quantity.

21. The non-transitory computer-readable medium of claim 12, wherein the instructions, when executed by the processing circuitry of the electronic device, cause the electronic device to:
allocate the first storage space in accordance with a first block capacity; and
allocate the second storage space in accordance with a second block capacity that is less than the first block capacity.

22. The non-transitory computer-readable medium of claim 12, wherein the instructions, when executed by the processing circuitry of the electronic device, cause the electronic device to:
access each of the one or more second blocks independently from other blocks of the memory device.

23. A method by a memory system, comprising:
allocating a first storage space of one or more first blocks of memory cells, of one or more memory arrays of a memory device formed in a respective quantity of levels above a semiconductor substrate, in accordance with the respective quantity of levels above the semiconductor substrate of the memory device; and
allocating a second storage space of one or more second blocks of memory cells, of the one or more memory arrays of the memory device, in accordance with a subset of the respective quantity of levels above the semiconductor substrate of the memory device.
